(19) United States
(12) Patent Application Publication
(10) Pub. No.: US 2024/0289609 A1
(43) Pub. Date: Aug. 29, 2024

(54) SYSTEM FOR TRAINING NEURAL NETWORK TO DETECT ANOMALIES IN EVENT DATA

(71) Applicant: Quantiphi, Inc, Marlborough, MA (US)

(72) Inventors: Dagnachew Birru, Marlborough, MA (US); Muneeswaran I, Mumbai (IN); Vishal Vaddina, Mumbai (IN); Dhruv Mathew, Marlborough, MA (US)

(73) Assignee: Quantiphi, Inc, Marlborough, MA (US)

(21) Appl. No.: 18/175,487

(22) Filed: Feb. 27, 2023

(51) Int. Cl. G06N 3/08; G06F 17/16; G06N 3/0455

(52) U.S. Cl. CPC G06N 3/08; G06F 17/16; G06N 3/0455

(57) ABSTRACT

Disclosed is a system and a method for training a neural network to detect one or more anomalies in an event data. The system comprises a processing arrangement, communicably coupled to a database configured to store the event data. Herein, the processing arrangement is configured to receive event data associated with a plurality of log events for a given time period, pre-process the received event data to generate refined event data, process the refined event data using an encoder architecture of the processing arrangement, to generate one or more event embeddings based on a first transformation model, and wherein the second encoder is configured to generate one or more contextual embeddings based on a second transformation model for each log event, and process the one or more contextual embeddings via at least one statistical technique to generate an embedding matrix to detect the one or more anomalies.

### TECHNICAL FIELD

The present disclosure generally relates to anomaly detection models. Specifically, the present disclosure relates to systems and methods for training a neural network to detect one or more anomalies in a log event data.

### BACKGROUND

Traditionally, with rapid growth of sensor and measurement technologies, an abundance of process data is available in real-time for technical processes such as, manufacturing processes. For instance, trace data is sensor data or log data logged by many different sensors during one or more processing steps in a manufacturing process. In other words, trace data includes signals measured from the sensors mounted on manufacturing tools during processing. This abundance of log event data provides an opportunity to develop a systematic performance prediction and monitoring approach to capture an underlying process complexity and enhances a process control capability.

In conventional approaches, the anomaly detection is performed manually by domain experts based on the level of expertise and knowledge in respective domains and thereby addressed as per requirement (such as, by service personnel or domain experts). This makes the process time-consuming and complex, and prone to significant inaccuracies, specifically while maintaining complex manufacturing processes such as, semiconductor manufacturing process, which often requires a strict control of hundreds or even thousands of process variables.

Existing solutions for anomaly detection of log events (i.e., event data) are required to perform log parsing for enabling analysis to detect the anomalies therein (if any). However, such solutions are prone to parsing errors that potentially result in a large number of inaccurately classified log events and thereby hinders the anomaly detection process. Moreover, such existing solutions lack semantic understanding of the log events and thereby are unable to effectively process the log events to detect the one or more anomalies therein.

Therefore, in light of the foregoing discussion, there exists a need to overcome the aforementioned drawbacks associated with the existing solutions and provide an improved system and method for training a neural network to detect one or more anomalies in an event data. The present disclosure provides a system and a method for training a neural network implementing a natural language-based model for extracting embeddings for each log event without losing valuable information such as, inherent parameters.

### SUMMARY

The present disclosure seeks to provide a method for training a neural network to detect one or more anomalies in an event data. The present disclosure also seeks to provide a system for training a neural network to detect one or more anomalies in an event data. An aim of the present disclosure is to provide a solution that overcomes at least partially the problems encountered in prior art.

In a first aspect, an embodiment of the present disclosure provides training a neural network to detect one or more anomalies in an event data, the system comprising a processing arrangement, communicably coupled to a database configured to store the event data, wherein the processing arrangement is configured to:
receive event data associated with a plurality of log events for a given time period;
pre-process the received event data to extract a set of tokens and positional encodings associated with each of the plurality of log events to generate refined event data,
process the refined event data using an encoder architecture of the processing arrangement, the encoder architecture comprising at least two encoders, wherein:
   a first encoder is configured to:
      map each token of the set of tokens based on the positional encodings associated with each token along with a time period associated with each of the plurality of log events in the refined event data to generate an event representation for the mapped set of tokens; and
      process the event representation for the set of tokens to generate one or more event embeddings for each of the log events from the plurality of log events in the refined event data based on a first transformation model; and
   a second encoder is configured to:
      process the one or more event embeddings for a given sequence of log events of the plurality of log events in the refined event data based on a second transformation model to generate one or more contextual embeddings for each log event; and
      simultaneously process the one or more contextual embeddings for each log event via at least one statistical technique to derive correlations between the plurality of log events associated with the set of tokens;
generate an embedding matrix utilizing the derived correlations between the plurality of log events; and
process the embedding matrix to detect the one or more anomalies in the event data.

In a second aspect, an embodiment of the present disclosure provides a computer readable storage medium having computer executable instruction that when executed by a computer system, causes the computer system to execute a method for detecting one or more anomalies in an event data, the method comprising:
receiving event data associated with a plurality of log events for a given time period;
pre-processing the received event data to extract a set of tokens and positional encodings associated with each of the plurality of log events to generate refined event data,
processing the refined event data using an encoder architecture of the processing arrangement, the encoder architecture comprising at least two encoders, wherein:
   a first encoder is configured for:
      map each token of the set of tokens based on the positional encodings associated with each token along with a time period associated with each of the plurality of log event in the refined event data to generate an event representation for the set of mapped tokens; and
      processing the event representation for the set of tokens to generate one or more event embeddings for each of the log events from the plurality of log events in the refined event data based on a first transformation model; and
   a second encoder is configured for:
      processing the one or more event embeddings for a given sequence of log events of the plurality of log events in the refined event data based on a second transformation model to generate one or more contextual embeddings for each log event; and
      simultaneously processing the one or more contextual embeddings for each log event via at least one statistical technique to derive correlations between the plurality of log events associated with the set of tokens;

generating an embedding matrix utilizing the derived correlations between the plurality of log events; and

processing the embedding matrix to detect the one or more anomalies in the event data.

In a third aspect, system for detecting one or more anomalies in an event data, the system comprising a processing arrangement, communicably coupled to a database, configured to:
input the event data to the trained neural network of the system; and
executing the trained neural network to detect the one or more anomalies in the event data.

Embodiments of the present disclosure substantially eliminate or at least partially address the aforementioned problems in the prior art, and enables detection of the one or more anomalies in an accurate and efficient manner.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a block diagram of a system for training a neural network to detect one or more anomalies in an event data, in accordance with an embodiment of the present disclosure;

FIG. 2 illustrates a flowchart listing steps involved in a method for training a neural network to detect one or more anomalies in an event data, in accordance with an embodiment of the present disclosure;

FIG. 3 illustrate exemplary illustrations depicting preprocessing step implemented on received event data for generating refined event data, in accordance with one or more embodiments of the present disclosure;

FIGS. 4A and 4B illustrate simplified depictions of working illustrations of a first encoder and a second encoder, in accordance with one or more embodiments of the present disclosure

FIG. 5 illustrates a simplified overall architecture of the first encoder model, in accordance with an embodiment of the present disclosure; and

FIGS. 6A to 6C are simplified overall architecture of the encoder architecture, in accordance with one or more embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, an embodiment of the present disclosure provides a training a neural network to detect one or more anomalies in an event data, the system comprising a processing arrangement, communicably coupled to a database configured to store the event data, wherein the processing arrangement is configured to:
receive event data associated with a plurality of log events for a given time period;
pre-process the received event data to extract a set of tokens and positional encodings associated with each of the plurality of log events to generate refined event data,
process the refined event data using an encoder architecture of the processing arrangement, the encoder architecture comprising at least two encoders, wherein:
   a first encoder is configured to:
      map each token of the set of tokens based on the positional encodings associated with each token along with a time period associated with each of the plurality of log events in the refined event data to generate an event representation for the mapped set of tokens; and
      process the event representation for the set of tokens to generate one or more event embeddings for each of the log events from the plurality of log events in the refined event data based on a first transformation model; and
   a second encoder is configured to:
      process the one or more event embeddings for a given sequence of log events of the plurality of log events in the refined event data based on a second transformation model to generate one or more contextual embeddings for each log event; and
      process the one or more contextual embeddings for each log event via at least one statistical technique to derive correlations between the plurality of log events associated with the set of tokens;
generate an embedding matrix utilizing the derived correlations between the plurality of log events; and
process the embedding matrix to detect the one or more anomalies in the event data.

In a second aspect, an embodiment of the present disclosure provides a computer readable storage medium having computer executable instruction that when executed by a computer system, causes the computer system to execute a method for detecting one or more anomalies in an event data, the method comprising:
receiving event data associated with a plurality of log events for a given time period;
pre-processing the received event data to extract a set of tokens and positional encodings associated with each of the plurality of log events to generate refined event data, processing the refined event data using an encoder architecture of the processing arrangement, the encoder architecture comprising at least two encoders, wherein:
   a first encoder is configured for:
      mapping each token of the set of tokens based on the positional encodings associated with each token along with the time period associated with each of the plurality of log event in the refined event data to generate an event representation for the set of mapped tokens; and
      processing the event representation for the set of tokens to generate one or more event embeddings for each of the log events from the plurality of log events in the refined event data based on a first transformation model; and
   a second encoder is configured for:
      processing the one or more event embeddings for a given sequence of log events of the plurality of log events in the refined event data based on a second transformation model to generate one or more contextual embeddings for each log event; and
      processing the one or more contextual embeddings for each log event via at least one statistical technique to derive correlations between the plurality of log events associated with the set of tokens;
generating an embedding matrix utilizing the derived correlations between the plurality of log events; and
processing the embedding matrix to detect the one or more anomalies in the event data.

In a third aspect, system for detecting one or more anomalies in an event data, the system comprising a processing arrangement, communicably coupled to a database, configured to:
input the event data to the trained neural network of the system; and
executing the trained neural network to detect the one or more anomalies in the event data.

A system for training a neural network to detect one or more anomalies in an event data. Throughout the present disclosure, the term “neural network” refers to a network which mimics the working of a human brain by involving a series of algorithms or models configured to recognize underlying relationships in a set of a data (i.e., the event data). Similar, to the manner in which a human brain works with via neurons, the working of neural networks is dependent on the artificial neurons (also termed as, artificial neural network (ANN). The neural network on being completely trained is then implemented to replace the human involvement resulting in an efficient fast-paced method for detecting the one or more anomalies (discrepancies or errors) in the event data. The system is configured to train the neural network to automatically detect one or more anomalies in the event data i.e., required to be detected for identifying anomalous log events (or entries) in the event data. Further, as used herein, the term “anomaly” refers to a behavior deviating from a normal or expected behavior, suggesting an underlying issue that leads to the generation of the anomaly of the one or more anomalies in the event data. The present disclosure is configured to identify data points, events, and/or observations in the event data that deviate from normal behavior i.e., exhibit anomalous behavior, wherein the anomalous behavior indicates critical incidents, such as technical issues or glitches, for instance, in manufacturing processes, data transfer processes, and the like. For the purposes of the present disclosure, the term “event data” as used herein relates to information associated with a plurality of log events, for example, security log data, or log data of any technical process, spanning over a given time period. For example, the event data may comprise information associated with a plurality of past log events spanning long durations such as, days, months, or even years of event data and thus, processing of such large log datasets becomes highly time consuming and resource intensive. It will be appreciated that the neural network may be trained to detect each of the one or anomalies in the event data and based on the implementation may detect anomalies in only part of the event data (such as, a given sequence of log events) to improve the efficiency of the system. Herein, the system is configured to train the neural network to act as a base model for various downstream tasks such as, but not limited to, anomaly detection and log clustering analysis in a supervised and self-supervised manner (or setting). In an embodiment, the neural network implements a customized BERT based model. In another embodiment, the neural network implements a sentence transformer model for extracting embeddings from the event data. The system may be further configured to modify the neural network based on a subset of the event data using Masked Language Modelling (MLM) task with an extended security logs vocabulary obtained while pre-processing the log messages to train the model to learn an internal representation of fine-grained log event messages and understand the effect of parameter values to make the system and/or neural network for anomaly detection resistant to log event modifications.

Existing solutions performing anomaly detection of log events (i.e., event data) are required to perform log parsing for enabling analysis to detect the anomalies therein (if any). However, such solutions are prone to parsing errors that potentially result in a large number of inaccurately classified log events and thereby hinders the anomaly detection process. Moreover, such existing solutions lack semantic understanding of the log events and thereby unable to effectively process the log events to detect the one or more anomalies therein. In order to overcome the aforementioned problems, the present disclosure provides a system and a method for training a neural network implementing a natural language-based model for extracting embeddings for each log event without losing valuable information such as, inherent parameters.

The system comprises a processing arrangement, communicably coupled to a database configured to store the event data to be checked or examined for anomaly detection via the system. The term “processing arrangement” as used herein refers to a structure and/or module that includes programmable and/or non-programmable components configured to store, process and/or share information and/or signals relating to the system for training a neural network to detect one or more anomalies in an event data. The processing arrangement may be a controller having elements, such as a display, control buttons or joysticks, processors, memory and the like. Typically, the processing arrangement is operable to perform one or more operations for training the neural network to detect one or more anomalies in an event data. In the present examples, the processing arrangement may include components such as memory, a processor, a network adapter and the like, to store, process and/or share information with other computing components, such as, a user interface, a user device, a remote server unit, a database arrangement. Optionally, the processing arrangement includes any arrangement of physical or virtual computational entities capable of enhancing information to perform various computational tasks. Further, it will be appreciated that the processing arrangement may be implemented as a hardware processor and/or plurality of hardware processors operating in a parallel or in a distributed architecture.

Optionally, the processing arrangement is supplemented with additional computation system including neural networks such as, Artificial (ANN), Convolutional (CNN), Recurrent (RNN), RCNNS, Multilayer Perceptron (MLP) and so forth and hierarchical clusters of pseudo-analog variable state machines implementing artificial intelligence algorithms. Optionally, the processing arrangement is implemented as a computer program that provides various services (such as database service) to other devices, modules or apparatus. Optionally, the processing arrangement includes, but is not limited to, a Tensor Processing Unit (TPU), Graphical Processing unit (GPU), a microprocessor, a micro-controller, a complex instruction set computing (CISC) microprocessor, a reduced instruction set (RISC) microprocessor, a very long instruction word (VLIW) microprocessor, Field Programmable Gate Array (FPGA) or any other type of processing circuit, for example as aforementioned. Additionally, the processing arrangement may be arranged in various architectures for responding to and processing the instructions for generating the notations via the method. Herein, the system elements may communicate with each other using a communication interface. The communication interface includes a medium (e.g., a communication channel) through which the system components communicate with each other. Examples of the communication interface include, but are not limited to, a communication channel in a computer cluster, a Local Area Communication channel (LAN), a cellular communication channel, a wireless sensor communication channel (WSN), a cloud communication channel, a Metropolitan Area Communication channel (MAN), and/or the Internet. Optionally, the communication interface comprises one or more of a wired connection, a wireless network, cellular networks such as 2G, 3G, 4G, 5G mobile networks, and a Zigbee connection.

In this regard, the “database” is configured to store information corresponding to the plurality of log events in the event data, computed embeddings and tokens associated therewith. Furthermore, the “database” is configured to store information associated with the plurality of base stations including parameter values associated with each of the plurality of log events in an organized manner for enabling efficient processing via the method. For example, the database stores data, files, and the like in any conventional format. More optionally, the database may be hardware, software, firmware and/or any combination thereof. For example, the database has data stored as digital information may be in a form of a diagram, a table, a map, a grid, a packet, a datagram, a file, a document, a list or in any other form. The database may include any data storage software and required system. More optionally, the database is communicatively coupled to the processing arrangement via a communication network. Typically, the database is a storage media that may store information about the plurality of log events in the event data either temporarily or permanently and at the same time dynamically store any change or update in the information associated therewith.

Herein, the processing arrangement is configured to receive event data associated with a plurality of log events for a given time period. Herein, the event data received by the processing arrangement comprises the plurality of log events associated with the given time period, for example, 1 hour, 2 hour, 6 hours, 12 hours, 24 hours, 1 week, 1 month, 1 year, and the like, and stored in the database for further processing thereof. The term “log event” as used herein refers to semi-structured text(s) associated with any technical process, wherein each log event has two components, namely, a fixed component (i.e., an event template) and a variable component (i.e., parameter values such as, IP address, file path, file size, and time-taken). However, such semi-structured or unstructured texts includes various inherent noises (such as, unwanted spaces, special characters, and the like) and are therefore required to be cleaned for enabling further processing of the plurality of log events in the event data via the processing arrangement. Thus, in order to clean the received event data i.e., to clean (or refine) the plurality of log events in the received event data, the processing arrangement is further configured to pre-process the received event data to remove the inherent noise to extract a set of tokens and positional encodings associated with each of the plurality of log events to generate refined event data. Herein, the processing arrangement is configured to preprocess the event data, i.e., pre-process the plurality of log events in the event data to extract the set of tokens associated with each of the plurality of log events in the event data and include log parameters therewith to generate the refined event data. The term “log parameter” as used herein refers to processing parameters associated with the plurality of log events in the event data. The one or more log parameters may include, but are not limited to, a location or address, an identifier (such as, process ID or trace identifiers), a size, a path, and a time period, associated with the plurality of log events. Notably, the time period refers to the time interval between two consecutive log events in the event data and may include a start time, an end time, or duration therebetween, and may further be utilized via the processing arrangement during further processing. The term “refined event data” refers to processable (or usable) information associated with a plurality of cleaned (or refined) log events generated via preprocessing of the plurality of log events in the event data via the processing arrangement. In an example, the event data comprises a raw log event: “System A connected to System B via 113:24:100”. Herein, after preprocessing via the processing arrangement, the event data is converted into the refined event data comprising the refined log event: “system A connected to system B via 1 1 3 2 4 1 0 0”. Beneficially, such a preprocessing step of the processing arrangement enables further processing of the event data via extraction of useful information in a desired manner that enables the processing arrangement to further process and analyze the event data to detect the one or more anomalies in an efficient manner. It should be noted that, the above is an exemplary example of preprocessing performed by the processing arrangement and any preprocessing of log events that refines or cleans the log events to produce refined event data are considered as alternatives without deviating from the spirit and scope of the invention.

In one or more embodiments, to preprocess the received event data, the processing arrangement is configured to obtain a set of semantic tokens from the event data and perform at least one cleaning technique on each token of the set of semantic tokens to generate one or more tokens associated with each of the plurality of log events, or arrange the generated one or more tokens, to generate the refined event data. Typically, the processing arrangement is configured to obtain the set of semantic tokens, via conventional extraction techniques, that may further be processed via the at least one cleaning technique to generate one or more tokens to be associated and further processed via the processing arrangement. Herein, the processing arrangement may be configured to remove the unwanted (or undesired) special characters from each log event of the plurality of log events and simultaneously include parameter values for obtaining the one or more tokens associated therewith. However, since such parameter values correspond to generation of variable tokens and thereby to address the issues regarding such problematic variable tokens, the processing arrangement is configured to modify the event data or the plurality of log events therein via the at least one cleaning technique to generate the refined event data. For example, the processing arrangement may be configured to add a space between every digit of a number.

In one or more embodiments, to perform the at least one cleaning technique, the processing arrangement is configured to extract one or more blocks from the event data to provide the set of semantic tokens associated with the plurality of log events and modify at least one of the set of semantic tokens by removing special characters from a semantic token, splitting at least one keyword from a semantic token, replacing at least one semantic token with a substitute token extracted based on a substitute parameter and adding at least one keyword or parameter to a semantic token, to provide the one or more tokens of the refined event data. Herein, as explained earlier, the processing arrangement may be configured to remove the unwanted (or undesired) special characters from each log event of the plurality of log events and simultaneously include parameter values for obtaining the one or more tokens associated therewith. However, since such parameter values correspond to generation of variable tokens and thereby to address the issues regarding such problematic variable tokens, the processing arrangement is configured to modify the event data or the plurality of log events therein via the at least one cleaning technique to generate the refined event data. Typically, the processing arrangement may be configured to extracting parameter values, for obtaining the set of semantic tokens, such as, date and time, process ID, and trace identifiers. Further, the processing arrangement may be configured to removing different special characters such as, brackets (for example, [ ], { } and ( ), punctuations, or symbols (for example, @, <, =, >, and the like). Furthermore, the processing arrangement may be configured to split consecutive words in each of the plurality of log events such as, ‘blockMap’ to ‘block Map’, replace any identifier or operators such as, blk 1224 with blk, add a space between every digit of a number, within each of the plurality of log events to generate plurality of refined log events of the refined event data. Beneficially, the processing arrangement is enabled to extract useful and/or efficiently processable information into different blocks or tokens based on the respective metadata captured to understand the context or meaning of the plurality of log events and/or the parameters associated therewith.

In one or more embodiments, the database further comprises an event ontology generated via the processing arrangement, and wherein the event ontology is dynamically updated via addition of the one or more unique tokens. Herein, the processing arrangement is configured to include the time parameter i.e., time taken between two consecutive log entries is more relevant than the actual date and time, or include time interval information in the associated log event. As a result, additionally, pre-processing event messages in the collected log events via the processing arrangement enables generation of a dynamically updated vocabulary or ontology with the set of unique tokens occurring in the plurality of log events that may utilized to understand the semantics and/or context thereof. It will be appreciated that when such tokens are combined with positional encodings thereof as explained later in the present disclosure, the extracted tokens therefor may be considered as unique in view of unique locations or characters and the processing arrangement is enabled to understand the relevant meaning of the parameters. Thus, after pre-processing the event messages in the collected plurality of log events, the processing arrangement is configured to create the event ontology with the set of unique tokens occurring in the messages that is updated dynamically during pre-processing of the event data to improve the processing efficiency and efficacy of the system.

The processing arrangement is further configured to process the event data using an encoder architecture of the processing arrangement, the encoder architecture comprising at least two encoders, a first set of encoders and a second encoder. Throughout the present disclosure, the term “encoder architecture” refers to a structure and/or module comprising a set of encoders (or transformers) operatively coupled with each other and configured to enable the system (or processing arrangement) to accurately and efficiently detect the one or more anomalies in the event data. Optionally, the encoder architecture may be a part of an encoder-decoder architecture i.e., part of the processing arrangement and comprises one or more encoders and decoders therein. Typically, the encoder architecture comprises at least a first encoder and a second encoder that are part of the processing arrangement and may be configured to receive the event data for further processing to output a sequence of embeddings associated with the extracted set of tokens for further utilization thereof, and wherein the encoder architecture may comprise a suite of encoders (including the first and second encoders) to enable parallel processing for detection of the one or more anomalies in the event data in a quick and efficient manner. Herein, the first encoder(s) of the encoder architecture may be an encoder (or transformer) configured for processing of the raw event data to generate the event representation utilized for generation of the embedding vectors for further processing thereof. It will be appreciated that other types of encoders may be interchangeably utilized via the encoder architecture of the processing arrangement without any limitations to the present disclosure.

The system of the present disclosure provides a two-stage transformer-based encoder framework to derive a contextual representation of the plurality of log events in the refined event data based on correlation information across a given sequence of log events derived in a self-supervised manner. Generally, log events are semi-structured texts which are very noisy in nature and comprises inherent problems owing to the variable component i.e., parameter values such as, IP address, file path, file size, time-taken, etc. Since such parameter values are continuous variables and thereby comprise an infinite number of possible permutations and combinations, creation of embeddings for every token therein becomes unfeasible.

Thus, in light of the aforementioned problem, the present disclosure provides the encoder architecture i.e., a two-staged transformer-based framework to represent log sequences in a contextual embedding space. Specifically, in some embodiments, the encoder architecture may comprise a first encoder (customized event encoder) followed by a second encoder (a log sequence encoder) in a hierarchical arrangement, to extract contextual embeddings of a given log event(s) of the plurality of log events. Notably, the event encoder of the encoder architecture does not rely on log parsing algorithms and requires minimal domain knowledge. Moreover, in contrast to existing solutions, the encoder architecture is configured to derive a contextual understanding of both log event templates and parameters of each of the plurality of log events without any loss of useful information and thereby, enabling detection of the one or more anomalies in the event data in an efficient and accurate manner.

Herein, in the first encoder map each token of the set of tokens based on the positional encodings associated with each token along with a time period associated with each of the plurality of log events in the refined event data to generate an event representation for the mapped set of tokens and process the event representation for the set of tokens to generate one or more event embeddings for each of the plurality of log events in the refined event data based on a first transformation model.

The “encoder” refers to a structure and/or module configured to perform natural language processing (NLP) tasks to process the refined event data into a required format that can be processed via the processing arrangement (such as, via a decoder). Herein, the first encoder is configured to generate the one or more embeddings for each of the plurality of log events in the refined event data based on a first transformation model and thereby enable the system to map the generated one or more embeddings via the event representation. The first encoder (or the second encoder) may be built by stacking a set of multi-head attention modules configured for parallel encoding of the refined event data for enabling further processing via the processing arrangement. In an example, the encoder may be operable to convert a given cleaned log event of the refined event data into one or more vectors or embeddings. The term “embedding” as used herein refers to encapsulated data representing the extracted set of tokens in each of the plurality of log events in the refined event data and parameters associated therewith for description thereof to enable further analysis and/or processing via the processing arrangement. For example, the embeddings may be token embeddings representing dense vector representations of the plurality of log events, or a text embedding associated therewith, to be encoded via the encoder for analysis and/or processing. In the context of anomaly detection via the system, the one or more embeddings are generated for representation of extracted tokens of each of the plurality of log events in a reduced or compressed format to enable faster processing via the encoder architecture. For example, the description of the refined event data and/or the plurality of log events therein, can be vectorized into a sparse one-dimensional or two-dimensional matrix based on the needs of the implementation. Herein, the encoder may map each of one or more embeddings based on the one or more parameters to generate the contextualized embeddings, which can further act as input for various downstream processing tasks via the system. Additionally, positional embeddings may be added to the generated series of event embeddings to retain positional information of each extracted set of tokens in the refined event data. For example, via 1-D positional embeddings, or 2-D aware positional embeddings, wherein the resulting sequence of embedding vectors serves as input to the encoder. In the context of the first encoder positional encodings refer to position of each token. For example: “System A turned off” here, position p1—system, p2—A, p3—turned, p4—off.

The term “event representation” as used herein refers to token-level representation(s) in a latent semantic space for each of the plurality of log events in the refined event data based on the positional encodings and time period associated therewith. Typically, the processing arrangement is configured to map each of the plurality of log events (or messages) to the event representation based on the positional encoding and time period taken for enabling generation of the one or more event embeddings (or contextualized event embedding vectors), which can act as input for various downstream tasks.

Further, the “first transformation model” refers to a transformer encoder only model configured to map each of the extracted set of tokens i.e., the log event message(s) to an n-dimensional semantic latent space representation i.e., the event representation. In one or more embodiments, the first transformation model is configured to map each of the set of tokens to the event representation, wherein the event representation is a multi-dimensional semantic latent space representation generated using the one or more event embeddings, and wherein the number of dimensions in the multi-dimensional semantic latent space representation range from 128 to 256, or 256 to 512, or 512 to 1024, or 1024 to 2048. It will be appreciated that the number of dimensions of the event representation may be varied based on the implementation to beneficially improve the efficiency and speed of the encoder.

In one or more embodiments, the first encoder of the encoder architecture is a log event encoder, wherein the log event encoder is configured to implement a Bidirectional Encoder Representations from Transformers (BERT) based language model to obtain the one or more event embeddings (or embedding vectors) for each of the set of extract tokens via the token-level event representation of the plurality of log events. The embedding vector obtained from first encoder serves as an input to existing forecasting-based anomaly detection models, log sequence classification and/or clustering models, and the like, that may be utilized via the processing arrangement. It will be appreciated that any other suitable forecasting-based anomaly detection model may be utilized via the processed arrangement without any limitations.

In one or more embodiments, the first encoder of encoder architecture of the processing arrangement is configured to implement a sentence-transformer model, wherein the first transformation model is an encoder only sentence transformer-based language model configured to generate one or more sentence event embeddings for the set of tokens. Typically, the first encoder may be configured to implement the sentence-transformer based models i.e., SBERT models to generate the one or more sentence embeddings complimentary, or as replacement, to the one or more event embeddings for enabling faster and more accurate generation of contextualized embedding vectors to be utilized via the processing arrangement to detect the one or more anomalies therein.

However, since log events or messages are not entirely similar to general natural language text i.e., they contain words or sub-tokens that are not included in the event ontology (or tokenizer vocabulary). In light of the aforementioned problem, the processing arrangement is further configured to extend the event ontology by adding the unique tokens extracted during preprocessing of the event data and thereby implemented on a given sequence of log events of the plurality of log events in the refined event data to determine normal behavior for the event data to enable detection of the one or more anomalies therefor. Moreover, optionally, the processing arrangement is configured to implement a Masked Language Modeling technique for domain adaptation on a subset of the plurality of log events in the refined event data to derive or obtain contextual understanding of the plurality of log events or messages in the event data while consuming (or processing) lesser log data with lesser training time of the neural network for anomaly detection in comparison to learning from scratch. Additionally, the first encoder further comprises a pooling layer to pool the output across the set of tokens and return an event embedding vector of the associated log event of the plurality of log events.

Beneficially, the one or more event embeddings may build on temporal and structural similarities of the plurality of log events to learn the low dimensional representation the event data for efficient and accurate anomaly detection. Notably, the event representation successfully captures latent structures and similarities between the plurality of log events (or a given sequence thereof for faster processing) at different time instants and/or time periods to predict the final outcome i.e., detection of the one or more anomalies in the event data. The processing arrangement may be configured to combine log event contexts built by sampling locally a (higher-order) event representation of the extracted set of tokens of the refined event data, which in turn define the complex patterns characterizing the semantics and dynamics of the plurality of log events in the refined event data.

Further, herein, the second encoder is configured to process the one or more event embeddings for a given sequence of log events of the plurality of log events in the refined event data based on a second transformation model to generate one or more contextual embeddings for each log event and simultaneously process the one or more contextual embeddings for each log event via at least one statistical technique to derive correlations between the plurality of log events associated with the set of tokens.

The term “second encoder” as used herein refers to a structure and/or module configured for processing of log event sequences or embeddings to derive contextual information therefrom. Alternatively stated, the second encoder is a log sequence encoder i.e., a transformer-based log sequence model configured to map each of the one or more event embeddings (E) to the event representation vector space (C) with a contextual understanding of the given sequence of log events of the plurality of log events to determine behavioral information associated therewith. Typically, the second encoder of the encoder architecture is a transformer encoder model with a multi-head attention mechanism, configured for extraction of contextual information from a given sequence of log events from the plurality of log events using the generated one or more embeddings for the set of extracted tokens to learn the patterns and/or relations within a given sequence (for example, normal log sequence) of log events from the plurality of log events via at least two self-supervised training techniques, namely, a Masked Log Modeling—for predicting the probable embedding of log events in the given sequence of log events from the plurality of log events that are randomly masked therefor, and a Next Event Decoder—for training the model to predict the embedding of next incoming log event, i.e. given 20 log events in a sequence, predict the 21st event and so on.

In one or more embodiments, the encoder of the encoder architecture may receive instances corresponding to a given time period from the log event data received from various data sources. In particular, the neural network may receive prior log event data which may be log event data corresponding to a prior (sample) time period to a current time period for which the event data needs to be analyzed for detecting the one or more anomalies therein. In one or more embodiments of the present disclosure, the neural network is an autoencoder comprising an encoder and a decoder, and wherein the encoder is trained on the refined event data and the decoder is implemented to re-construct the log event data. The described autoencoder utilizing the encoder and the decoder may be contemplated by a person skilled in the art and thus has not been described in detail herein for the brevity of the present disclosure. Such autoencoder may be able to “predict” sequences that are unpredictable for forecasting models (such as ARIMA, RNN forecast, moving-average). Further, such autoencoder also works with short and long cycles/runs of the plurality of log events in the refined event data as would be required for implementation of embodiments of the present disclosure.

According to embodiments of the present disclosure, the neural network would need to predict “normal” instances of log event data for the given time period, as would be discussed later in the disclosure in detail. For this purpose, the neural network may need to be trained on refined log event data representing normal operating conditions (NOC) for the process to be analyzed. Thus, herein, the prior log event data may be selected from available multiple sequences of log events, from the refined log event data, representing the normal operating conditions for the process to be analyzed to detect the one or more anomalies therein. Herein, selection of the given sequence of log events, from the received time-series data, may be based on characterizing a normal behavior for the refined event data for at least a defined time period. This may involve characterizing the normal behavior of each of the plurality of log events (or portion thereof) in the refined event data. In an example, the normal behavior may be characterized by a relatively stationary curve, i.e., trend and volatility are almost constant, in which the stationary trend may be modelled via plurality of modelling means to define predictions therein. Additionally, the processing arrangement is configured to evaluate the quality of contextualized log sequence embeddings by performing anomaly detection tasks in both supervised and self-supervised settings. It is well known in the art that, supervised training requires both normal and anomalous data during the training phase in large volume, whereas self-supervised training requires only normal/ideal data during the training phase. Obtaining or simulating large volume of anomalous data may be a difficult and time-consuming task. Furthermore, since the nature of anomalous events change dynamically, anomalous data set used in a training environment, might not be similar enough to help the system learn effectively to identify anomalies in real time production environment.

In one or more embodiments, the second transformation model is a vanilla-transformer-based encoder architecture implementing the multiheaded attention mechanism configured to simultaneously process the one or more contextual embeddings for each of the set of tokens via the at least one statistical technique to derive the correlations between the plurality of log events. Typically, the one or more embeddings obtained from the first encoder represent log messages and parameters associated with each of the plurality of log events in the refined event data, wherein the second encoder of the encoder architecture is configured to determine correlations between the plurality of events based on the sequence of log event to detect anomalous behavior (based on deviation from normal behavior). Herein, the second encoder is a vanilla transformer-based encoder with multiheaded attention mechanism to understand the correlations in the given log sequence. Herein, the processing arrangement may be configured to stack such encoder layers of the second encoder together and customize the number of encoder layers and the number of attention heads per layer to improve the computational efficiency of the encoder architecture. Herein, the second encoder is configured to utilize the generated one or more embeddings (via the first encoder) for processing thereof using the multiheaded attention mechanism to generate the respective contextual embeddings. Notably, the “attention mechanism” refers to a mechanism or process of interpretation and extraction of contextual information from the generated embeddings for enabling detection of anomalies in the associated log event(s) of the refined event data. In one or more embodiments, the second encoder implements one or more attention mechanisms including, but not limited to, Bahdanau Attention, Transformer self-attention, for deriving correlations between the plurality of log events in the refined event data. In one or more embodiments, the decoder implements one or more of: a Recurrent Neural Network (RNN) with a Gated Recurrent Unit (GRU) decoder, a RNN with a Long Short-Term Memory (LSTM) decoder, a Transformer with self-attention decoder. Beneficially, the implementation of the attention mechanism to decode the generated contextual embeddings improves the accuracy of the output and therefor the classification of each of the plurality of log events and/or the set of tokens associated therewith i.e., whether anomalous or not, in an efficient manner.

Notably, the second encoder obtains (or selects) the sequence of log event embeddings computed using the first event encoder as input along with positional embeddings associated therewith. As explained earlier, the first encoder maps each of the plurality of log events at corresponding time instant (or period) ‘t’ to the one or more embedding vectors (eₜ). Further, the second log sequence encoder is configured to obtain a sequence of log event embeddings: ‘E’={e₁, e₂, . . . , eₜ, eₜ₊₁, . . . , eₙ}⊏R^{n×de} as input and maps the sequence of embeddings into the contextual embedding vectors ‘C’={c₁, c₂, . . . , cₜ, cₜ₊₁, . . . , cₙ}⊏R^{n×dc}, wherein, ‘eₜ’ refers event embedding for a single log entry at time ‘t’, ‘cₜ’ refers to contextual embeddings comprising the derived correlations and having an accurate understanding of the given log sequence in an efficient manner due to the multi-headed attention mechanism, ‘dₑ’ and ‘d_{c}’ are the output dimensions of eₜ (i.e., the first encoder) and cₜ (i.e., the second encoder) for each of the plurality of log events.

The processing arrangement is further configured to generate an embedding matrix utilizing the derived correlations between the plurality of log events and process the embedding matrix to detect the one or more anomalies in the event data. Typically, the output contextual embeddings (ct) are utilized for generating the embedding matrix ‘C’ to be further utilized via the processing arrangement to be used for various downstream tasks such as log sequence classification, cluster analysis, and prediction of the next incoming log events as explained earlier. Similarly, the processing arrangement can detect the one or more anomalous log events (or anomalies) by predicting the most probable embedding of an incoming log event and identifying or detecting an anomaly, if the log event violates the normal behavior such as, via implementation of a Next Event Decoder head along with the encoder-architecture of the processing arrangement. Notably, in supervised settings, the neural network is capable of detecting anomalous behavior for each event in the given log sequence with respect to other events in the sequence.

In one or more embodiments, the encoder architecture of the processing arrangement is configured to process the embedding matrix by performing the at least one statistical technique comprising at least one of masked log modelling, log event classification, log events cluster analysis, auto-regressive analysis, and log event prediction, on the embedding matrix to detect the one or more anomalies in the event data. The system of the present disclosure may be further configured for evaluating the performance of anomaly detection (as a downstream task) using the neural network as the base model to perform different statistical techniques in different embodiments of the present disclosure.

In an embodiment, the processing arrangement is configured to implement a masked log decoder to perform masked log modelling (statistical technique) and thereby enable the processing arrangement (and the neural network) to detect anomalous sequences by computation of correlation, or comparison, with rest of log events in the given log sequence of the plurality of log events in a self-supervised manner. In another embodiment, the processing arrangement is configured to implement a next event decoder for log event prediction or decoding of an embedding vector associated with an incoming (or future) log event. In another embodiment, the processing arrangement is configured to implement a classifier head decoder (i.e., a classification head) to classify the given sequence of log events (i.e., classification at sequence level), and each of the log events in the given sequence of log events (i.e., classification at event level), using supervised learning objectives.

In one or more embodiments, to perform log event prediction statistical technique to detect the one or more anomalies, the processing arrangement further comprises a decoder operatively coupled to the first and second encoder of the encoder architecture. The term “decoder” refers to a structure and/or module configured to decode or predict an output at a particular time instant based on the input received i.e., the embeddings (or encoder vectors) from the encoder that acts as an initial hidden state of the decoder. Further, the decoder may act as a prediction head, or a classification head, or a masked modelling head, or an auto-regressive head, implementing a multilayer perceptron (MLP) head having at least one hidden layer generated during the pre-processing step to be converted to a single linear layer or embedding to be further utilized for accurate detection of the one or more anomalies via the processing arrangement or system. Optionally, the decoder is a Transformer and comprise inherent benefits of increased computational efficiency and accuracy in comparison to RNNs; since, the transformer decoder is enabled to parallelly process given sequence(s) from the plurality of log event(s) of the refined event data to beneficially improve the computational efficiency of the processing arrangement for detection the one or more anomalies in the event data during training of the neural network and obtain information from previous and future states via the combination of a look ahead masking operation and the attention mechanisms implemented via the processing arrangement or system. Notably, during training, some decoders of the processing arrangement, such as, a RNN decoder with a gated recurrent unit (GRU), or a RNN decoder with LSTMs, are configured for recurrent processing for improved efficacy, while, some decoders such as, transformer decoders, are configured for parallel processing (or decoding) for improved efficiency. Moreover, during inference, each of the decoders in the processing arrangement are configured for recurrent prediction i.e., event-by-event until the entire possible sequences of the plurality of log events (or a required part thereof) may be processed via the processing arrangement.

In such embodiments, the processing arrangement is configured to select at least one of the one or more event embeddings for each of the set of tokens in the event representation, process, via the first encoder, the selected at least one of the one or more event embeddings based on a first transformation model to generate a standard embedding matrix, and the remaining of the one more event embeddings based on the second transformation model to generate a predicted embedding matrix (i.e., exhibiting normal or standard behavior). Herein, the selected at least one of the one or more event embeddings may correspond to an incoming log event or a future log event, for example, corresponding to the given sequence of log events, and processed via the first encoder using the first transformation model (that may or may not be different from the second transformation model used for generation of contextual embeddings) to generate the standard embedding matrix and correspondingly remaining of the one or more event embeddings are processed via the second encoder using the second transformation model to generate the predicted embedding matrix. Further, the decoder may be configured to simultaneously process the one or more contextual embeddings for each of the set of tokens via the multiheaded attention mechanism to derive correlations between the plurality of log events associated with the set of tokens. Notably, the decoder is a next event decoder implemented in a self-supervised manner to predict the next probable incoming event's embedding vector matrix via addition of a single head attention layer followed by a fully connected layer on top of the base log sequence encoder model i.e., the second encoder model. Herein, the decoder head outputs an embedding vector matrix of the next probable incoming log event i.e., the predicted embedding matrix.

Furthermore, the decoder is configured to determine a degree of dissimilarity for each of the set of tokens based on a similarity score of the predicted embedding matrix with the standard embedding matrix. Alternatively stated, the decoder is configured to compute the similarity score of the predicted embedding matrix with the standard embedding matrix and based on which determine the degree of dissimilarity with respect to each of the set of tokens associated for granular prediction and/or analysis via the processing arrangement. Notably, the “similarity score” refers to a measure of similarity between any two tokens of the extracted set of tokens in each of the two compared matrix(es) and may be determined using comparison of the predicted embedding matrix and the standard embedding matrix based on any conventional distance measure such as, but not limited to, cosine dis-similarity measure, Manhattan distance, Euclidean distance, and the like.

In one or more embodiments, the processing arrangement, or encoders, and/or decoders therein, may be configured to compute the similarity score based on the cosine similarity between the predicted event embedding vector (e̊ᵢ) and the actual event and an embedding vector (eᵢ) for each of the masked log events.

Typically, the similarity score i.e., the cosine similarity score is calculated using the formula:

$$sim ( . ) = cos cos □ = \frac{\vec{u} \times \vec{v} \cdot }{\vert \vec{u} \vert \times \vert \vec{v} \vert \cdot } ;$$

whereas, the degree of dissimilarity is determined using cosine-dissimilarity score Lₛᵢₘ(eᵢ, êᵢ)=1−sim(eᵢ, êᵢ). Notably, in the training phase, only normal log sequences are used to minimize the loss function,

$${L}_{M L M} = \frac{1}{m} {Σ}_{i = 1}^{m} {L}_{s i m} ( {e}_{i} , {\hat{e}}_{i} ) ,$$

‘m’ indicates total number of masked events in the given log sequence. In the testing phase, if a given log sequence has a cosine-dissimilarity score beyond a certain threshold, we consider that log sequence as anomalous i.e., exhibiting anomalous behaviour.

Upon determination of the similarity score of the predicted embedding matrix with the standard embedding matrix, the degree of dissimilarity may be determined, wherein if the degree of dissimilarity for any of the predicted embedding matrix with the standard embedding matrix is greater than or equal to a first predefined threshold, the decoder is configured to identify and/or detect the anomalous log event associated with the anomalous embedding matrix for detecting the one or more anomalies in the event data. Herein, based on the determined degree of dis-similarity between predicted next event embedding (êⁿ⁺¹) and actual incoming event embedding (eⁿ⁺¹), the decoder may classify the actual log event embedding as anomalous if the determined dissimilarity measure is greater than the first predefined threshold. Notably, during training of the neural network, the processing arrangement is configured to minimize the cosine-dissimilarity score therebetween, whereas during inference via the neural network, if the dissimilarity score violates the learned standard or normal behavior i.e., exceeds the first predefined threshold, the n+1th event is detected as an anomalous event.

In one or more embodiments, to perform the masked log modelling statistical technique on the embedding matrix, the second encoder of the processing arrangement is further configured to select at least one of the one or more event embeddings for each token of the set of tokens in the event representation, process, via the first encoder, the selected at least one of the one or more event embeddings based on the first transformation model to generate a standard masked embedding matrix and the remaining of the one more event embeddings to generate a predicted embedding matrix. The processing arrangement is further configured to be pretrained to learn the normal behavior using the at least one statistical technique for a self-supervised learning objective i.e., Masked Log Modeling. Herein, the selected at least one of the one or more event embeddings may correspond to masked log events, for example, a part, or a predefined percentage (e.g. 10%, 20%, etc.), either randomly or in a predefined manner corresponding to the given sequence of log events, and processed via the first encoder using the first transformation model (that may or may not be different from the second transformation model used for generation of contextual embeddings) to generate the masked standard embedding matrix and correspondingly remaining of the one or more event embeddings are processed via the second encoder using the second transformation model to generate the predicted embedding matrix. Furthermore, the decoder is configured to process the one or more contextual embeddings for each of the set of tokens via a multi-headed attention mechanism to derive correlations between the plurality of log events associated with the set of tokens and determine a degree of dissimilarity for each of the set of tokens based on a similarity score of the masked standard embedding matrix with the predicted embedding matrix to determine an anomalous embedding matrix, if the degree of dissimilarity for any of the masked embedding matrix with the standard embedding matrix is greater than or equal to a second predefined threshold; and, if so, detect the anomalous log event associated with the anomalous embedding matrix for detecting the one or more anomalies in the event data. The decoder may be configured to process the one or more contextual embeddings for each of the set of tokens via the multiheaded attention mechanism to derive correlations between the plurality of log events associated with the set of tokens. Notably, the decoder is a masked log decoder implemented in a self-supervised manner to determine the masked embedding vector matrix via addition of a multi head attention layer followed by a fully connected layer on top of the base log sequence encoder model i.e., the second encoder model. Herein, the decoder head outputs an embedding vector matrix of the masked log events i.e., the masked embedding matrix. During inference phase via the neural network, the processing arrangement may declare a log sequence as anomalous when the similarity score between learned and actual embeddings varies significantly.

In one or embodiments, to perform log event classification prediction on the embedding matrix, the processing arrangement is further configured to process the embedding matrix via a classified head decoder based on a classification algorithm to provide classification outputs to each embedding matrix, wherein the classification outputs includes either an anomalous embedding matrix or a normal embedding matrix. For classification tasks, the processing arrangement comprises a stack of fully connected encoder layers followed by activation functions on top of the second encoder model. The classification algorithm may be based on:

$${L}_{C L S} = \frac{- 1}{n} {Σ}_{i = 1}^{n} . {Σ}_{j = 1}^{N c} {\hat{y}}_{i}^{j} log {y}_{i}^{j} .$$

Similar to token classification, we have an N_{c}-dimensional output for each log event in the given sequence, wherein ŷᵢ^{j} represents the output probability of class ‘j’ associated with log event ‘i’ of the sequence of log events and hence, ‘y’ belongs to Rₙ. Typically, for a given log sequence with a window size of ‘n’, the corresponding output dimension will be n×N_{c}, wherein the window size ‘n’ represents the total number of log events present in the given log sequence, and ‘Nc’ represents the total number of output classes. During anomaly detection using classification, the processing arrangement is further configured to provide classification outputs to each embedding matrix, wherein the classification outputs includes either an anomalous embedding matrix or a normal embedding matrix. Alternatively stated, for such a classification operation via the processing arrangement, only two output classes are available i.e., anomaly and normal behavior. Correspondingly, the processing arrangement may set N_{c}=2 to obtain binary output for each event. If all the events in the log sequence indicate a normal behavior, then the given log sequence is considered or deemed as a normal sequence, whereas if at least one event has been classified as an anomaly, then the given log sequence is deemed as an anomalous sequence via the processing arrangement.

In a third aspect, the present disclosure provides a computer readable storage medium having computer executable instruction that when executed by a computer system, causes the computer system to execute a method for detecting one or more anomalies in an event data. The method comprises receiving event data associated with a plurality of log events for a given time period, pre-processing the received event data to extract a set of tokens and positional encodings associated with each of the plurality of log events to generate refined event data, processing the refined event data using an encoder architecture of the processing arrangement, the encoder architecture comprising at least two encoders, wherein a first encoder is configured for mapping each token of the set of tokens based on the positional encodings and time period associated with each of the plurality of log events in the refined event data to generate an event representation for the set of mapped tokens and processing the event representation for the set of tokens to generate one or more event embeddings for a given sequence of log events of the plurality of log events in the refined event data based on a first transformation model; and, wherein the second encoder is configured for processing the one or more event embeddings for each of the sequence of log events in the refined event data based on a second transformation model to generate one or more contextual embeddings for each log event and processing the one or more contextual embeddings for each log event in the sequence of log events via at least one statistical technique to derive correlations between the plurality of log events associated with the set of tokens and generating an embedding matrix utilizing the derived correlations between the plurality of log events and processing the embedding matrix to detect the one or more anomalies in the event data.

In a fourth aspect, the present disclosure provides a computer program comprising computer executable program code, when executed the computer executable program code controls a computer system to perform the method. Notably, the computed program provided in the present disclosure has a modular program code that enables the method and system to selectively utilize the encoder-decoder architecture of the processing arrangement for training the neural network to detect one or more anomalies in an event data.

### DETAILED DESCRIPTION OF THE DRAWINGS

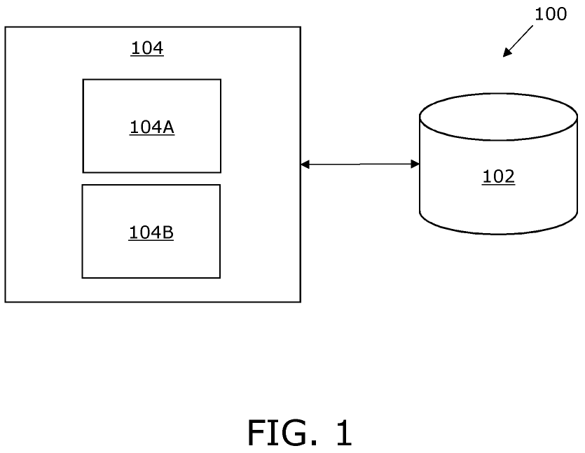

Referring to FIG. 1, illustrated is a block diagram of a system 100 for training a neural network to detect one or more anomalies in an event data, in accordance with an embodiment of the present disclosure. As shown, the system 100 comprises a database 102 configured to store the event data and a processing arrangement 104. Herein, the processing arrangement 104 is configured to receive event data associated with a plurality of log events for a given time period, pre-process the received event data based on one or more log parameters to extract a set of tokens and positional encodings associated with each of the plurality of log events to generate refined event data. Further, the processing arrangement 104 is configured to process the refined event data using an encoder architecture of the processing arrangement, the encoder architecture comprising at least two encoders 104A and 104B. Herein, a first encoder 104A is configured to map each token of the set of tokens based on the positional encodings and time period associated with each of the plurality of log events in the refined event data to generate an event representation for the mapped set of tokens and process the event representation for the set of tokens to generate one or more event embeddings for each log event in the given sequence of log events in the refined event data based on a first transformation model. Furthermore, the second encoder 104B is configured to process the one or more event embeddings for the given sequence of log events of the plurality of log events in the refined event data based on a second transformation model to generate one or more contextual embeddings for each log event and process the one or more contextual embeddings for each log event via at least one statistical technique to derive correlations between the plurality of log events associated with the set of tokens. Moreover, the processing arrangement 104 is further configured to generate an embedding matrix utilizing the derived correlations between the plurality of log events and process the embedding matrix to detect the one or more anomalies in the event data.

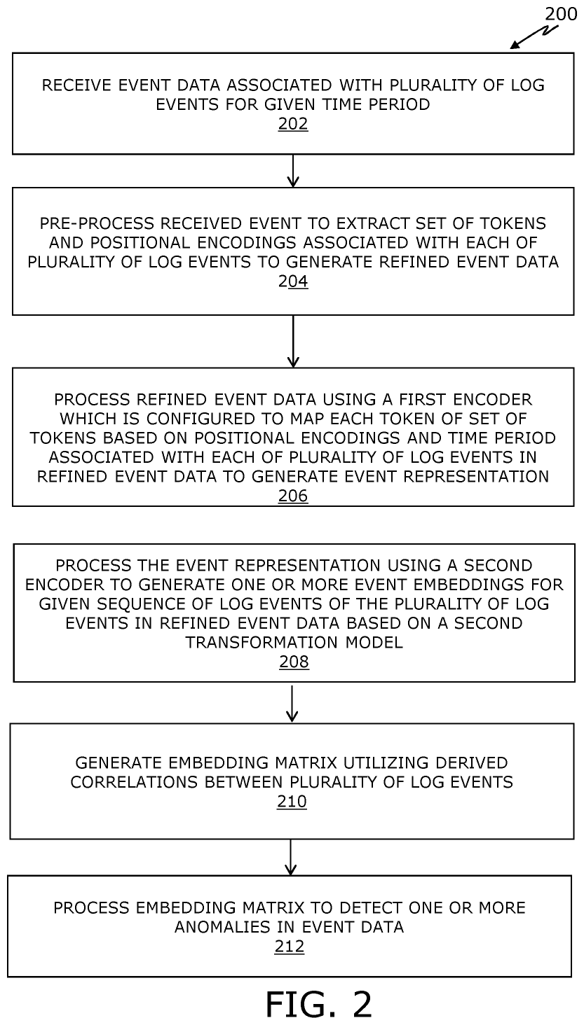

Referring to FIG. 2, illustrated is a flowchart listing steps involved in a method for detecting one or more anomalies in an event data, in accordance with an embodiment of the present disclosure. As shown, the method 200 comprising steps 202, 204, 206, 208, 210 and 212. At a step 202, the method 200 comprises receiving event data associated with a plurality of log events for a given time period. At a step 204, the method 200 further comprises pre-processing the received event data to extract a set of tokens and positional encodings associated with each of the plurality of log events to generate refined event data. At a step 206, the method 200 further comprises processing the refined event data using an first encoder architecture of the processing arrangement, the encoder architecture comprising at least two encoders, wherein at the step 206, the first encoder 104A is configured for mapping each token of the set of tokens based on the positional encodings and time period associated with each of the plurality of log events in the refined event data to generate an event representation for the set of mapped tokens and processing the event representation for the set of tokens to generate one or more event embeddings for a given sequence of log events of the plurality of log events in the refined event data based on a first transformation model. Further, at the step 208, the second encoder 104B is configured for processing the one or more event embeddings for each log event of the given sequence of log events in the refined event data based on a second transformation model to generate one or more contextual embeddings for each log event and simultaneously processing the one or more contextual embeddings for each log event via at least one statistical technique to derive correlations between the plurality of log events associated with the set of tokens. At a step 210, the method 200 further comprises generating an embedding matrix utilizing the derived correlations between the plurality of log events, and at a step 212, the method 200 comprises processing the embedding matrix to detect the one or more anomalies in the event data.

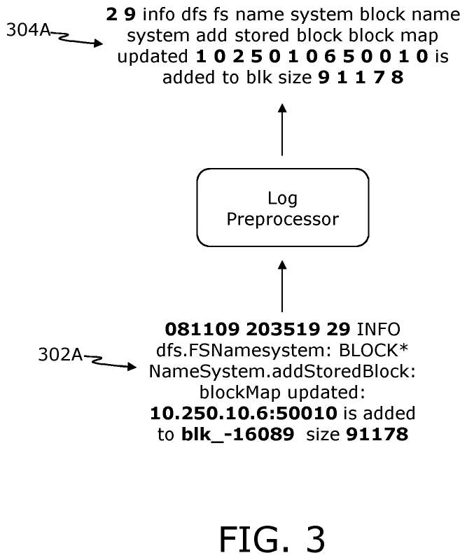

Referring to FIG. 3, illustrated are exemplary illustrations depicting preprocessing step 204 implemented on received event data, via the processing arrangement 104, for generating refined event data, in accordance with one or more embodiments of the present disclosure. As shown, in FIG. 3, the raw log message i.e., the event data 302A, is converted into a cleaned log message i.e., the refined event data 304A.

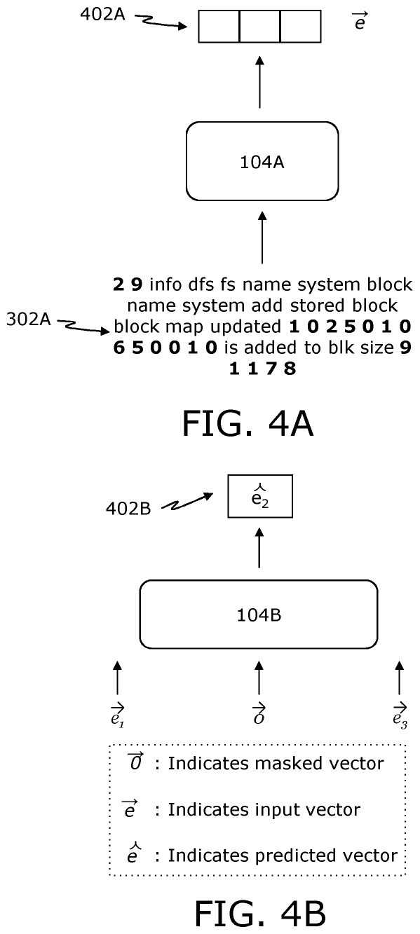

Referring to FIGS. 4A and 4B, illustrated are simplified depictions of working illustrations of the first encoder 104A and the second encoder 104B of the processing arrangement 104, respectively, in accordance with one or more embodiments of the present disclosure. As shown in FIG. 4A, the first encoder 104A is configured to map each cleaned log event message 302A to an n-dimensional semantic latent space representation i.e., the event representation 402 using the first transformation model (a transformer-based language model). Further shown in FIG. 4B, the second encoder 104B performs Masked Log Modelling to attain an understanding of log sequences using the second transformation model i.e., a transformer encoder only model by zeroing out the event embedding vectors and predict the true embeddings 402B for generating the true event data for enabling efficient and accurate anomaly detection via the trained neural network.

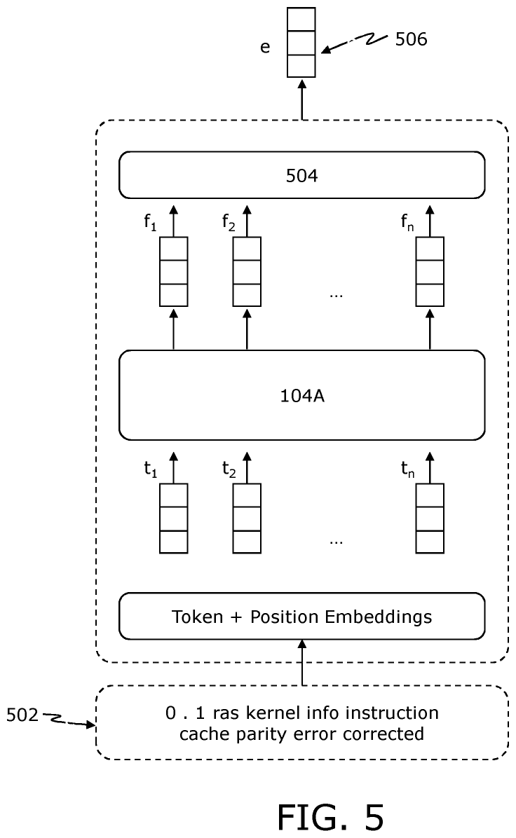

Referring to FIG. 5, illustrated is a simplified overall architecture of the first encoder model 104A, in accordance with an embodiment of the present disclosure. As shown, the first encoder 104A is configured to map each token of the set of tokens based on the positional encodings and time period associated with each of the plurality of log events in the refined event data 502 to generate an event representation 504 for the mapped set of tokens and process the event representation 504 for the set of tokens to generate one or more event embeddings 506 for a given sequence of log events of the plurality of log events in the refined event data based on a first transformation model.

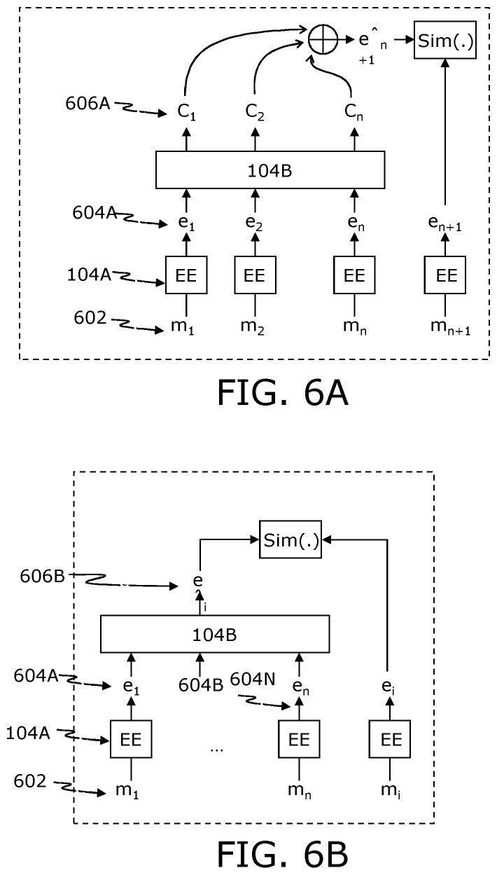

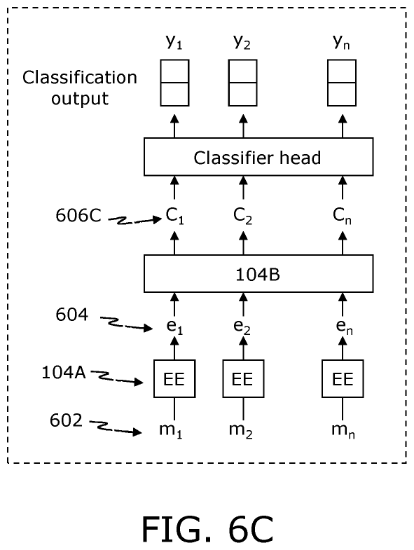

Referring to FIGS. 6A to 6C, illustrated are simplified overall architecture of encoder-architecture 104, in accordance with one or more embodiments of the present disclosure. Herein, the first encoder 104A (denoted as ‘EE’) is configured to map each token of the set of tokens based on the positional encodings and time period associated with each of the plurality of log events in the refined event data 602 to generate an event representation 604 for the mapped set of tokens and process the event representation 604 for the set of tokens to generate one or more event embeddings (such as, the one or more event embeddings 506 of FIG. 5) for a given sequence of log events of the plurality of log events in the refined event data 602 based on a first transformation model.

As shown in FIG. 6A, the at least one statistical technique employed is a log event prediction technique, wherein the second encoder is configured to process the one or more event embeddings 604 for the given sequence of log events of the plurality of log events in the refined event data 602 based on a second transformation model to generate one or more contextual embeddings 606A for each log event and simultaneously process the one or more contextual embeddings 606A for each log event via log event prediction as the at least one statistical technique to derive correlations between the plurality of log events associated with the set of tokens. Herein, the processing arrangement 104 is configured to select each of the at least one embedding (e₁ . . . eₙ) of the one or more event embeddings 604 for each of the set of tokens in the event representation, process, via the second encoder 104B, the one or more event embeddings based on a second transformation model to generate a predicted embedding matrix. Wherein the decoder i.e., a next event decoder, is configured to process the one or more next event embeddings (eₙ₊₁) 604 for each of the set of tokens to derive a standard embedding matrix and determine a degree of dissimilarity for each of the set of tokens based on a similarity score of the predicted embedding matrix with the standard embedding matrix, determine an anomalous embedding matrix, if the degree of dissimilarity for any of the predicted embedding matrix with the standard embedding matrix is greater than or equal to a first predefined threshold; and, if so, identify the anomalous log event associated with the anomalous embedding matrix for detecting the one or more anomalies in the event data 602.

As shown in FIG. 6B, the at least one statistical technique employed is a masked modelling technique, wherein the second encoder 104B is configured to process the one or more event embeddings 604 for the given sequence of log events of the plurality of log events in the refined event data 602 based on a second transformation model to generate one or more contextual embeddings 606B for each log event and simultaneously process the one or more contextual embeddings 606B for each log event via log event prediction technique as the at least one statistical technique to derive correlations between the plurality of log events associated with the set of tokens. Herein, the processing arrangement 104 is configured to select at least one embedding of the one or more event embeddings 604 for each of the set of tokens in the event representation and replace the selected embedding(s) with masked embeddings (zero vector) 604B. The selected event embeddings are considered standard embedding matrix. The second encoder processes the one or more event embeddings 604 based on the second transformation model to generate the predicted embedding matrix 606B for masked embeddings 604B. The second encoder generates the predicted embedding matrix 606B by correlating with the rest of the event embeddings 604. For example, given a set of log event messages (m1, m2, . . . m15) and their event embeddings from first encoder e1, e2 . . . e15, let us consider that a selected event embedding e7 is masked (replaced with zeros). The entire sequence of event embeddings e1, e2 . . . e15 is sent to second encoder (including the masked e7). The role of second encoder is now to look at (e1, e2 . . . e6) and (e8, e9 . . . e15) basically everything except the masked e7, and predict what could have been the e7. This is the predicted embedding matrix. A comparison is now made between both the predicted e7 and actual e7 (without masking) from the standard embedding matrix and a determination is made if the log event message m7 is anomalous. This is done by calculating a degree of dissimilarity for each of the set of tokens based on a similarity score of the predicted embedding matrix 606B with the standard embedding matrix, determine an anomalous embedding matrix if the degree of dissimilarity for any of the predicted embedding matrix with the standard embedding matrix is greater than or equal to a first predefined threshold; and, if so, identify the anomalous log event associated with the anomalous embedding matrix for detecting the one or more anomalies in the event data 602.

As shown in FIG. 6C, the at least one statistical technique employed is a log event classification technique, wherein the second encoder 104B is to perform log event classification prediction on the embedding matrix 606C, the processing arrangement is further configured to process the embedding matrix 606C via a classified head decoder based on a classification algorithm to provide classification outputs (yₙ) to each embedding matrix 606C, wherein the classification outputs includes either an anomalous embedding matrix or a normal embedding matrix.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for training a neural network to detect one or more anomalies in an event data, the system comprising a processing arrangement, communicably coupled to a database configured to store the event data, wherein the processing arrangement is configured to:
receive event data associated with a plurality of log events for a given time period;
pre-process the received event data to extract a set of tokens and positional encodings associated with each of the plurality of log events to generate refined event data,
process the refined event data using an encoder architecture of the processing arrangement, the encoder architecture comprising at least two encoders, wherein:
a first encoder is configured to:
map each token of the set of tokens based on the positional encodings associated with each token along with the time period associated with each of the plurality of log event in the refined event data to generate an event representation for the mapped set of tokens; and
process the event representation for the set of tokens to generate one or more event embeddings for each of the log events from the plurality of log events in the refined event data based on a first transformation model; and
a second encoder is configured to:
process the one or more event embeddings for a given sequence of log events of the plurality of log events in the refined event data based on a second transformation model to generate one or more contextual embeddings for each log event; and
simultaneously process the one or more contextual embeddings for each log event via at least one statistical technique to derive correlations between the plurality of log events associated with the set of tokens;
generate an embedding matrix utilizing the derived correlations between the plurality of log events; and
process the embedding matrix to detect the one or more anomalies in the event data.

2. The system according to claim 1, wherein to preprocess the received event data, the processing arrangement is configured to:
obtain a set of semantic tokens from the event data; and
perform at least one cleaning technique on each token of the set of semantic tokens to generate one or more tokens associated with each of the plurality of log events; or
arrange the generated one or more tokens to generate the refined event data.

3. The system according to claim 2, wherein to perform the at least one cleaning technique, the processing arrangement is configured to:
extract one or more blocks from the event data to provide the set of semantic tokens associated with the plurality of log events; and
modify at least one of the set of semantic tokens by removing special characters from a semantic token, splitting at least one keyword from a semantic token, replacing at least one semantic token with a substitute token extracted based on a substitute parameter and adding at least one keyword or parameter to a semantic token, to provide the one or more tokens of the refined event data.

4. The system according to claim 1, wherein the first transformation model is configured to map each of the set of tokens to the event representation, wherein the event representation is a multi-dimensional semantic latent space representation generated using the one or more event embeddings, and wherein the number of dimensions in the multi-dimensional semantic latent space representation range from 128 to 256, or 256 to 512, or 512 to 1024, or 1024 to 2048.

5. The system according to claim 4, wherein the first encoder of the encoder architecture is configured to implement a sentence-transformer model, the first transformation model is an encoder only sentence transformer-based language model, configured to generate one or more sentence event embeddings for the set of tokens.

6. The system according to claim 1, wherein the second transformation model is a vanilla transformer-based encoder architecture implementing the multiheaded attention mechanism configured to process the one or more contextual embeddings for each of the set of tokens via the at least one statistical technique to derive the correlations between the plurality of log events.

7. The system according to claim 1, wherein the encoder architecture of the processing arrangement is configured to process the embedding matrix by performing the at least one statistical technique comprising at least one of masked log modelling, log event classification, log events cluster analysis, auto-regressive analysis, and log event prediction, on the embedding matrix to detect the one or more anomalies in the event data.

8. The system according to claim 7, wherein to perform log event prediction statistical technique to detect the one or more anomalies, the processing arrangement further comprises a decoder operatively coupled to the first and second encoder of the encoder architecture, wherein the processing arrangement is configured to:
select at least one of the one or more event embeddings for each of the set of tokens in the event representation;
process, via a first encoder, the selected at least one of the one or more event embeddings based on a first transformation model to generate a standard embedding matrix, and the remaining of the one more event embeddings based on the second transformation model to generate a predicted embedding matrix; and, wherein the decoder is configured to:
process the one or more contextual embeddings for each of the set of tokens via a multi-headed attention mechanism to derive correlations between the plurality of log events associated with the set of tokens; and
determine a degree of dissimilarity for each of the set of tokens based on a similarity score of the predicted embedding matrix with the standard embedding matrix;
determine an anomalous embedding matrix, if the degree of dissimilarity for any of the predicted embedding matrix with the standard embedding matrix is greater than or equal to a first predefined threshold; and, if so,
identify the anomalous log event associated with the anomalous embedding matrix for detecting the one or more anomalies in the event data.

9. The system according to claim 7, wherein to perform the masked log modelling statistical technique on the embedding matrix, the second encoder of the processing arrangement is further configured to:
select at least one of the one or more event embeddings for each token of the set of tokens in the event representation;
process, via the first encoder, the selected at least one of the one or more event embeddings based on the first transformation model to generate a masked embedding matrix and the remaining of the one more event embeddings to generate a predicted embedding matrix; and wherein the decoder is configured to:
process the one or more contextual embeddings for each of the set of tokens via a multi-headed attention mechanism to derive correlations between the plurality of log events associated with the set of tokens; and
determine a degree of dissimilarity for each of the set of tokens based on a similarity score of the predicted embedding matrix with the masked embedding matrix;
determine an anomalous embedding matrix, if the degree of dissimilarity for any of the masked embedding matrix with the predicted embedding matrix is greater than or equal to a second predefined threshold; and, if so,
detect the anomalous log event associated with the anomalous embedding matrix for detecting the one or more anomalies in the event data.

10. The system according to claim 7, wherein to perform log event classification prediction on the embedding matrix, the processing arrangement is further configured to process the embedding matrix via a classified head decoder based on a classification algorithm to provide classification outputs to each embedding matrix, wherein the classification outputs includes either an anomalous embedding matrix or a normal embedding matrix.

11. The system according to claim 1, wherein the first encoder is an event encoder and the second encoder is a log sequence encoder and the decoder is one of an attention head decoder, a classifier head decoder, a masked log decoder.

12. The system according to claim 1, wherein the database further comprises an event ontology generated via the processing arrangement, and wherein the event ontology is dynamically updated via addition of the one or more tokens.

13. A system for detecting one or more anomalies in an event data, the system comprising a processing arrangement, communicably coupled to a database, configured to:
input the event data to the trained neural network of claim 1; and
executing the trained neural network to detect the one or more anomalies in the event data.

14. A computer readable storage medium having computer executable instruction that when executed by a computer system, causes the computer system to execute a method for detecting one or more anomalies in an event data, the method comprising:
receiving event data associated with a plurality of log events for a given time period;
pre-processing the received event data to extract a set of tokens and positional encodings associated with each of the plurality of log events to generate refined event data,
processing the refined event data using an encoder architecture of the processing arrangement, the encoder architecture comprising at least two encoders, wherein:
a first encoder is configured for:
map each token of the set of tokens based on the positional encodings associated with each token along with the time period associated with each of the plurality of log event in the refined event data to generate an event representation for the set of mapped tokens; and
processing the event representation for the set of tokens to generate one or more event embeddings for each of the log events from the plurality of log events in the refined event data based on a first transformation model; and
a second encoder is configured for:
processing the one or more event embeddings for a given sequence of log events of the plurality of log events in the refined event data based on a second transformation model to generate one or more contextual embeddings for each log event; and
processing the one or more contextual embeddings for each log event via at least one statistical technique to derive correlations between the plurality of log events associated with the set of tokens;
generating an embedding matrix utilizing the derived correlations between the plurality of log events; and
processing the embedding matrix to detect the one or more anomalies in the event data.
